(19) United States
(12) Patent Application Publication
(10) Pub. No.: US 2023/0303198 A1
(43) Pub. Date: Sep. 28, 2023

(54) SMART BIKE FOR LOW VISION

(71) Applicant: United States Government as Represented by the Department of Veterans Affairs, Washington, DC (US)

(72) Inventor: Brian Higgins, Washington, DC (US)

(21) Appl. No.: 18/188,052

(22) Filed: Mar. 22, 2023

Related U.S. Application Data
(60) Provisional application No. 63/322,894, filed on Mar. 23, 2022.

(51) Int. Cl. B62J 50/22; B62J 45/41; B62J 45/42; B62M 6/50

(52) U.S. Cl. CPC B62J 50/22; B62J 45/41; B62J 45/42; B62M 6/50; G01S 17/931

(57) ABSTRACT

Methods, systems, and apparatuses are described that are configured for determining a forward path of a transportation device, receiving sensor data, determining, based on the sensor data, one or more objects in the forward path of the transportation device, and causing output of audio and tactile feedback to enable an operator of a transportation device to avoid the one or more objects.

### CROSS REFERENCE TO RELATED PATENT APPLICATION

This application claims priority to U.S. Provisional Application No. 63/322,894, filed Mar. 23, 2022, which is herein incorporated by reference in its entirety.

### BACKGROUND

Conventional assistive technology available to visually impaired individuals typically involve the use of a white cane device and trained guide dogs. However, these assistive technologies have not been significantly updated or improved since their respective introductions. A conventional white cane investigates the environment via a user sweeping the cane side to side in a three foot pattern. The white cane user may be able to sense objects in his/her path that come into contact with the white cane as he/she sweeps the cane side to side. A guide dog may guide a person in one or more directions based on commands received from the person. The guide dog may assist the person in avoiding objects in a given object and assists the visually impaired person from making physical contact with objects in the environment. In addition to white cane devices and trained guide dogs, there are three main product types that aid visually impaired individuals for safe navigation through their environments, such as electronic travel aids (ETAs), electronic orientation aids (EOAs), and position locator devices (PLDs). The use of a variety of sensors, cameras, and other technologies capable of gathering and relaying information about proximal surroundings for clear path navigation can be used in tandem with conventional methods of transportation. However, there has been difficulty in adapting these technologies for being conveniently used with convention methods of transportation in assisting visually impaired individuals in navigating surrounding environments.

For example, bicycles have been used to navigate environments at a greater pace than simply walking to a desired destination. Bicycles traditionally used for those that are visually impaired typically involve the use of a tandem bicycle where visually impaired individuals cycle by riding tandem, or attached, to a sighted person cycling with the visually impaired individual. A visually impaired person that cycles individually without a sighted person riding tandem would have to exercise additional caution in order to avoid any potential obstacles that may appear in the person's cycling path. Visually impaired persons can enjoy the use of a device that may be attached to a bicycle to help assist the person in detecting objects, or obstacles, appearing in the person's cycling path. However, there are limitations to the use of this device because it is only designed to be used on a supervised cycle track.

### SUMMARY

It is to be understood that both the following general description and the following detailed description are exemplary and explanatory only and are not restrictive. Methods, systems, and apparatus for providing an improved method of providing a clear path detection and object avoidance via a transportation device are described.

In an embodiment is a transportation device comprising a steering device, affixed to the transportation device, a sensor affixed to a front portion of the transportation device, wherein the sensor is four degrees centered on either side from a forward path of the transportation device, wherein the sensor is configured to generate sensor data, a first haptic feedback fixture affixed to a left side of the steering device, wherein the first haptic feedback fixture comprises a tactile feedback device, a second haptic feedback fixture affixed to a right side of the steering device, wherein the second haptic feedback fixture comprises a tactile feedback device, a computing device in communication with the sensor and the first and second haptic feedback fixtures, wherein the computing device is configured to determine the forward path of the transportation device, receive the sensor data, determine, based on the sensor data, one or more objects in the forward path of the transportation device, determine, based on the one or more objects in the forward path of the transportation device, directional data, cause, based on the directional data indicating the one or more objects in a left direction of the transportation device, the first haptic feedback fixture to output, via the tactile feedback device of the first haptic feedback fixture, a vibration output to avoid the one or more objects in the left direction of the transportation device, and cause, based on the directional data indicating the one or more objects in a right direction of the transportation device, the second haptic feedback fixture to output, via the tactile feedback device of the second haptic feedback fixture, a vibration output to avoid the one or more objects in the right direction of the transportation device.

In an embodiment, the sensor is a Light Detection and Ranging (LIDAR) sensor, wherein to determine the one or more objects in the forward path of the transportation device, the computing device is configured to receive LIDAR sensor data from the LIDAR sensor, and determine, based on the LIDAR sensor data, a position of an object.

In an embodiment, the computing device is affixed to the transportation device.

In an embodiment, the computing device is a smartphone, smart watch, a smart glass, a tablet, or a laptop.

In an embodiment, the transportation device is a bicycle.

In an embodiment, each haptic feedback fixture further comprises a speaker device, and the computing device is further configured to cause, based on the directional data indicating the one or more objects in a left direction of the transportation device, the first haptic feedback fixture to output, via the speaker device of the first haptic feedback fixture, a voice output to avoid the one or more objects in the left direction of the transportation device, and cause, based on the directional data indicating the one or more objects in a right direction of the transportation device, the second haptic feedback fixture to output, via the speaker device of the second haptic feedback fixture, a voice output to avoid the one or more objects in the right direction of the transportation device.

In an embodiment, the computing device comprises a GPS component configured to determine turn-by-turn guidance associated with the forward path, and cause, based on the turn-by-turn guidance associated with the forward path, a voice output and a vibration output associated with the turn-by-turn guidance.

In an embodiment, methods, systems, and apparatuses are provided for determining a forward path of a transportation device, receiving sensor data, determining, based on the sensor data, one or more objects in the forward path of the transportation device, determining, based on the one or more objects in the forward path of the transportation device, directional data, and causing, based on the directional data, a voice and a vibration output associated with the directional data.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system;

FIG. 2 shows an example system;

FIG. 3 shows an example handle bar;

FIG. 4 shows an example haptic feedback fixture;

FIGS. 5A-5B show an example sensor affixed to a bicycle;

FIGS. 6A-6C show an example sensor design;

FIG. 7 shows a flowchart of an example process;

FIGS. 8A-8B show an example protective enclosure;

FIGS. 9A-9B show example mounting mechanisms; and

FIG. 10 shows a flowchart of an example method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user” may indicate a person who uses an electronic device.

As used herein, the terms “path,” or “forward path” may indicate a direction in which the transportation vehicle, or bicycle, is moving in a forward direction. The term “environment” may indicate a primary area of focus in the forward path of the bicycle.

Methods and systems are described for a smart bicycle system. The smart bicycle system may include a smart vision system affixed to a bicycle for scanning the environment in proximity to the bicycle and smart vision system. The environment is a primary area of focus for navigational guidance travel for the blind. The smart vision system may comprise one or more sensors to scan the environment. The one or more sensors may include but are not limited to a Light Detection and Ranging (LIDAR) sensor. The smart vision system may comprise haptic feedback fixtures located on the left handlebar and the right handlebar of the bicycle. Each haptic feedback fixture may comprise a speaker device and a tactile feedback device (e.g. vibration motor). A computing device may be in communication with the one or more sensors and the haptic feedback fixtures. The computing device may receive sensor data from the one or more sensors and cause the haptic feedback fixtures to provide audio and/or tactile feedback in response to the sensor data indicating one or more objects in the forward path of the bicycle. The audio feedback may comprise a voice output, while the tactile feedback may comprise a vibration output.

The smart bicycle system may comprise a cargo rack, affixed to the bicycle. The smart bicycle system may further comprise a sensor mount, affixed to the cargo rack. The one or more sensors may be affixed to the sensor mount. The computing device of the smart bicycle system may receive guidance information (e.g., wirelessly) from an external computing device, such as a smartphone, tablet, and/or smartwatch. For example, the computing device may receive map data and/or directions from the external computing device. The computing device may cause the one or more haptic feedback fixtures to provide voice and/or vibration output associated with the map data and/or directions.

In an example, the smart vision system may be affixed to an electric bike. The computing device of the smart vision system may engage a motor of the electric bicycle to traverse a path and/or avoid an obstacle such as an object detected by the one or more sensors.

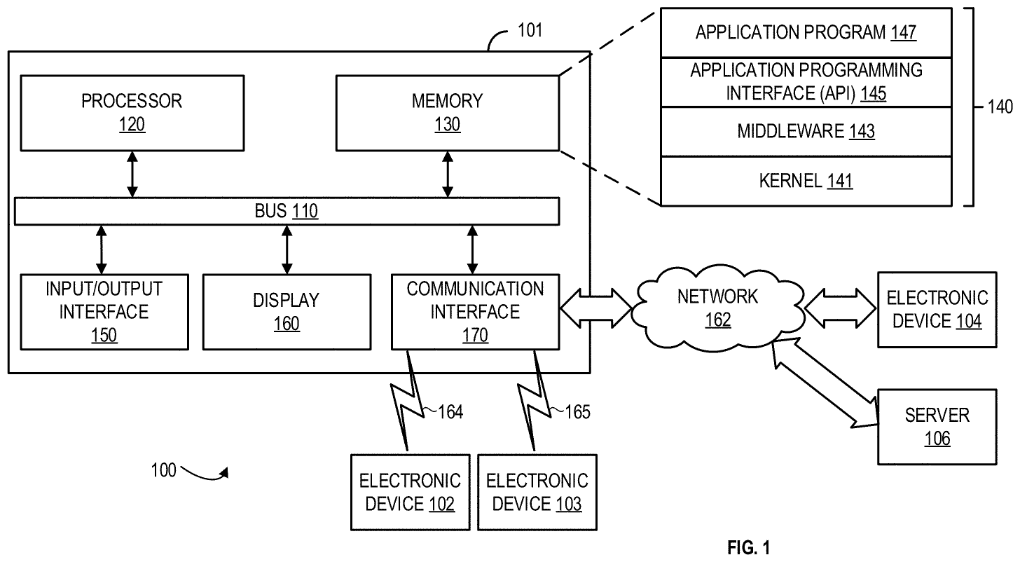

FIG. 1 shows an example system 100 including a computing/electronic device (e.g., smartphone) 101 configured for controlling one or more guidance systems of one or more electronic devices (e.g., the smart vision system) according to various embodiments. The computing device 101 may include a bus 110, a processor 120, a memory 130, an input/output interface 150, a display 160, and a communication interface 170. In an example, the electronic device 101 may omit at least one of the aforementioned constitutional elements or may additionally include other constitutional elements. The computing device 101 may comprise one or more of a mobile phone, a smart phone, a tablet computer, a laptop, a desktop computer, a smartwatch, a smart glass, and the like.

The bus 110 may include a circuit for connecting the processor 120, the memory 130, the input/output interface 150, the display 160, and the communication interface 170 to each other and for delivering communication (e.g., a control message and/or data) between the processor 120, the memory 130, the input/output interface 150, the display 160, and the communication interface 170.

The processor 120 may include one or more of a Central Processing Unit (CPU), an Application Processor (AP), and a Communication Processor (CP). The processor 120 may control, for example, at least one of the memory 130, the input/output interface 150, the display 160, and the communication interface 170 and/or may execute an arithmetic operation or data processing for communication. The processing (or controlling) operation of the processor 120 according to various embodiments is described in detail with reference to the following drawings.

The memory 130 may include a volatile and/or non-volatile memory. The memory 130 may store, for example, a command or data related to at least one different constitutional element of the computing device 101. In an example, the memory 130 may store a software and/or a program 140. The program 140 may include, for example, a kernel 141, a middleware 143, an Application Programming Interface (API) 145, and/or an application program (or an “application”) 147, or the like, configured for controlling one or more functions of the computing device 101 and/or an external device. At least one part of the kernel 141, middleware 143, or API 145 may be referred to as an Operating System (OS). The memory 130 may include a computer-readable recording medium having a program recorded therein to perform the method according to various embodiments by the processor 120.

The kernel 141 may control or manage, for example, system resources (e.g., the bus 110, the processor 120, the memory 130, etc.) used to execute an operation or function implemented in other programs (e.g., the middleware 143, the API 145, or the application program 147). Further, the kernel 141 may provide an interface capable of controlling or managing the system resources by accessing individual constitutional elements of the computing device 101 in the middleware 143, the API 145, or the application program 147.

The middleware 143 may perform, for example, a mediation role so that the API 145 or the application program 147 can communicate with the kernel 141 to exchange data.

Further, the middleware 143 may handle one or more task requests received from the application program 147 according to a priority. For example, the middleware 143 may assign a priority of using the system resources (e.g., the bus 110, the processor 120, or the memory 130) of the computing device 101 to at least one of the application programs 147. For example, the middleware 143 may process the one or more task requests according to the priority assigned to at least one of the application programs, and thus, may perform scheduling or load balancing on the one or more task requests.

The API 145 may include at least one interface or function (e.g., instruction), for example, for file control, window control, video processing, or character control, as an interface capable of controlling a function provided by the application 147 in the kernel 141 or the middleware 143.

The input/output interface 150 may be configured as an interface for delivering an instruction or data input from a user or a different external device(s) to the processor 120, the memory 130, the input/output interface 150, the display 160, and the communication interface 170. Further, the input/output interface 150 may output an instruction or data received from the processor 120, the memory 130, the input/output interface 150, the display 160, and/or the communication interface 170 to a different external device.

The display 160 may include various types of displays, such as, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 160 may display, for example, a variety of contents (e.g., text, image, video, icon, symbol, etc.) to the user. The display 160 may include a touch screen. For example, the display 160 may receive a touch, gesture, proximity, or hovering input by using a stylus pen or a part of a user's body.

The communication interface 170 may establish, for example, communication between the computing device 101 and an external device (e.g., a first external electronic device 102, a second external electronic device 103, a third external electronic device 104, or a server 106). For example, the communication interface 170 may communicate with the external device (e.g., the third external electronic device 104 or the server 106) by being connected to a network 162 through wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication may include, for example, a near-distance communication 164, 165. The near-distance communications 164, 165 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Universal Serial Bus (USB), High Definition Multimedia Interface (HDMI), Recommended Standard-232 (RS-232), power-line communication, Plain Old Telephone Service (POTS), and the like. The network 162 may include, for example, at least one of a telecommunications network, a computer network (e.g., LAN or WAN), the internet, and a telephone network.

Each of the first, second, and third external electronic devices 102, 103, and 104 may be the same type or a different type of device than the computing device 101. For example, the electronic device 102 may comprise a combination of sensors (e.g., one or more sensors) to identify objects in a path of an operator, and provide information associated with the identified objects to the computing device 101. The computing device 101 may be configured to determine directional data, based on the identified objects. The computing device 101 may be configured to use the directional data to cause haptic feedback fixtures affixed to the handlebars of the bicycle to provide voice and vibration outputs so as to guide the operator around the identified objects. For example, the electronic device 103 may include the haptic feedback fixtures. Additionally, the electronic device 103 may be configured by the computing device 101 to cause the haptic feedback fixtures to output a audio (e.g., voice) output and a vibration output indicating turn-by-turn guidance to follow a predetermined route to facilitate point-to-point travel by the operator (e.g., the “user”).

The server 106 may comprise a group of one or more servers. In an example, all or some of the operations executed by the computing device 101 may be executed in a different one or a plurality of electronic devices (e.g., the electronic device 102, the electronic device 104, or the server 106). In an example, if the computing device 101 needs to perform a certain function or service either automatically or based on a request, the computing device 101 may request at least some parts of functions related thereto alternatively or additionally to a different electronic device (e.g., the electronic device 102, the electronic device 104, or the server 106) instead of executing the function or the service autonomously. The different electronic devices (e.g., the electronic device 102, the electronic device 104, or the server 106) may execute the requested function or additional function, and may deliver a result thereof to the computing device 101. The computing device 101 may provide the requested function or service either directly or by additionally processing the received result. For example, a cloud computing, distributed computing, or client-server computing technique may be used. In an example, the computing device 101 may receive the sensor data from the electronic device 102 and output the sensor data to the server 106. The server 106 may be configured to process the sensor data to identify/determine one or more objects in a forward path of the bicycle and determine/generate directional data associated with a direction of the one or more objects in the forward path. The server 106 output the directional data to the computing device 101, wherein the computing device 101 may use the direction data to cause the haptic feedback fixtures to output audio (e.g., voice) output and vibration notifying the operator of the bicycle of the one or more objects in the forward path.

Each of the constitutional elements described in the present document may consist of one or more components, and names thereof may vary depending on a type of an electronic device. The electronic device according to various exemplary embodiments may include at least one of the constitutional elements described in the present document. Some of the constitutional elements may be omitted, or additional other constitutional elements may be further included. Further, some of the constitutional elements of the electronic device according to various exemplary embodiments may be combined and constructed as one entity, so as to equally perform functions of corresponding constitutional elements before combination.

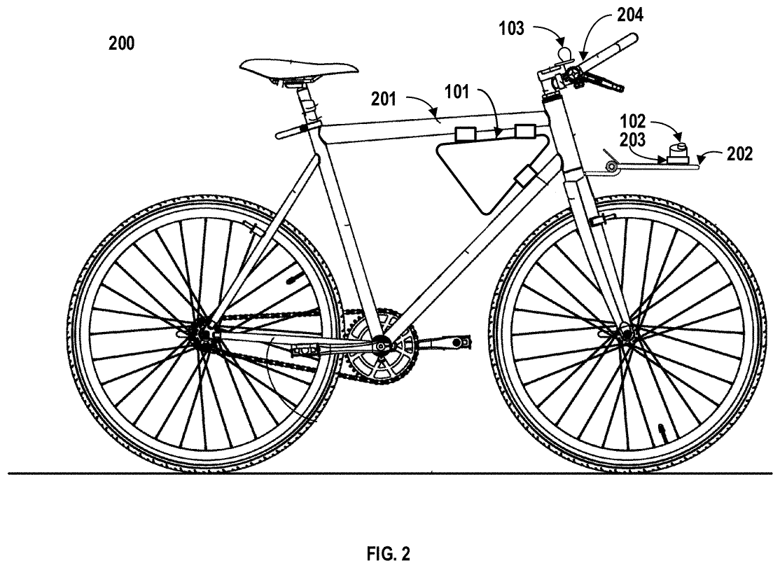

FIG. 2 shows an example smart bicycle system. The electronic device 102 may comprise one or more sensors 102. For example, the one or more sensors 102 may comprise one or more of LIDAR sensors, radar sensors, ultrasonic sensors, proximity sensors, infrared sensors, imaging sensors, GPS sensors, optical flow sensors, any combinations thereof, and the like. The electronic device 102 may comprise a LIDAR sensor, affixed to the bicycle 201. The LIDAR sensor 102 may be configured for scanning an environment in a forward path of the bicycle 201 and generating LIDAR data. The LIDAR sensor 102 may comprise a Slamtec 360 Lidar sensor that may be configured to provide omnidirectional laser range scanning to generate an outline map of its environment. While the sensor 102 is described throughout this disclosure as being a LIDAR sensor, it is to be understood that the sensor 102 may also comprise a radar sensor, sonar sensor, or other similar sensor.

A cargo rack 202 may be affixed to the bicycle 201 above the front wheel in order provide optimal visibility for the sensor without obstructing the operator's limited field of vision. A sensor mount 203 may be affixed to the cargo rack. The top surface of the sensor mount 203 may comprise a four-degree downward slope in order to orient the sensor scans to the surface in front of the bicycle 201. The sensor 102 may be affixed to the top surface of the sensor mount 203.

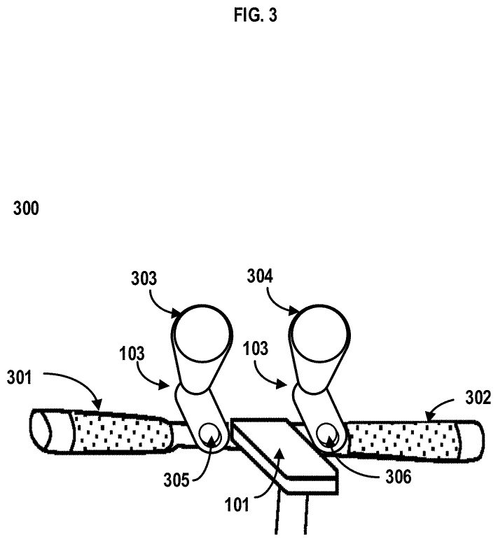

The electronic device 103 may comprise two or more haptic feedback fixtures. A first haptic feedback fixture 103 may be affixed to a left side of the steering device 204, or handlebar, and a second haptic feedback fixture 103 may be affixed to a right side of the steering device 204, or handlebar, as shown in FIG. 3. Each haptic feedback fixture 103 may comprise a speaker device 402 and a vibration motor 401, as shown in FIG. 4. In an example, the speaker device may comprise earphones, or earbuds, that may be separate devices from the haptic feedback fixtures 103. For example, the earphones, or earbuds, may be configured to communicate with the computing device 101 via a wired or wireless communication interface, wherein the computing device 101 may provide audio feedback to the user via the earphones, or earbuds.

The computing device 101 may comprise a computing device affixed to the bicycle 201, as shown in FIG. 2. Although, FIG. 2 shows a location of the computing device 101 affixed between the top and downward tubes of the bicycle 201, it is to be understood that the computing device 101 may be affixed to any optimal location on the bicycle 201. For example, as shown in FIG. 3, the computing device 101 may be affixed to the steering device (e.g., handlebar) of the bicycle 201. The computing device 101 may comprise one or more of a smartphone, a smart watch, a smart glass, a tablet, a laptop, any combinations thereof, and the like. The computing device 101 may comprise a mount or other system for affixing the computing device 101 to the bicycle 201. In an example, the computing device 101 may not be affixed to the bicycle 201. For example, the computing device 101 may comprise a mobile device, or other handheld computing device, capable of being carried on the user. The computing device 101 may be configured to receive the sensor data, determine, based on the sensor data, one or more objects in the path of the bicycle 201, and cause, based on the one or more objects in the path of the bicycle 201, the haptic feedback fixtures 103 to output an audio (e.g., voice) output and/or a vibration output to enable a user of the bicycle 201 to avoid the one or more objects in the path of the bicycle 201. The computing device 101 may be configured to transmit the sensor data to a server 106, wherein the server 106 may be configured to process the sensor data to determine directional data indicative of a direction of the one or more objects in the path of the bicycle 201.

The computing device 101 may comprise a GPS component. For example, the computing device 101 may use the GPS component to determine turn-by-turn guidance associated with a forward path of the bicycle 201 and cause, based on the turn-by-turn guidance, the haptic feedback fixtures 103 to output audio (e.g., voice) and tactile feedback associated with the turn-by-turn guidance. In an example, the computing device 101 may use the GPS component to determine turn-by-turn guidance associated with the forward path and output, via a speaker of the haptic feedback fixture 103, audio (e.g., voice) output associated with the turn-by-turn. For example, the speaker may output audible directions associated with making right and/or left turns, progressing down the path for a certain distance or period of time, combinations thereof, and the like.

To determine the one or more objects in the path of the bicycle, the computing device 101 may be configured to determine, based on the LIDAR data, a position of an object. For example, the computing device 101 may be configured to determine directional data based on the determination of the one or more objects in the path of the electronic device 102. The computing device 101 may be configured to repeat this process so as to continually, or continuously, update the position of the object relative to the bicycle 201 (and by extension, the operator of the bicycle 201). The computing device 101 may be configured to cause, based on the directional data indicating the one or more objects in a left direction of the bicycle 201, the first haptic feedback fixture 103 to output an audio (e.g., voice) output and/or a vibration output to avoid the one or more objects in the left direction of the bicycle 201, and cause, based on the directional data indicating the one or more objects in a right direction of the bicycle 201, the second haptic feedback fixture 103 to output an audio (e.g., voice) output and/or a vibration output to avoid the one or more objects in the right direction of the bicycle 201.

In an example, the electronic device 102 may comprise a second computing device (e.g., electronic device 104), in communication with the electronic device 102 via the wireless network interface. The wireless network interface may comprise a Bluetooth connection, an antenna, or other suitable interface. For example, the wireless network interface may comprise a Bluetooth Low Energy (BLE) module. In an example, the wireless network interface and the electronic device 104 may be integrated in one unitary component, such as a RFduino microcontroller with built-in BLE module, a Nordic Semiconductor microcontroller, a Cypress microcontroller with BLE module, or a BLE enabled Raspberry Pi. The electronic device 104 may be configured to receive sensor data (environmental information) from one or more of the sensors of the electronic device 102. The electronic device 104 may output some or all of the environmental information to the computing device 101 over a wireless connection. The electronic device 104 may be configured to output some or all of the environmental information to the computing device 101 via a wired connection.

In an example, the bicycle 201 may comprise an electric bicycle. The electronic device 104 may be configured to receive, from the computing device 101, the directional data and engage, based on the directional data, a motor of the electric bicycle 201. The electronic device 104 may be configured to output and/or receive data via a wireless network interface to and/or from an external device (e.g., the computing device 101). For example, based on the directional data, the electronic device 104 may determine the forward path in front of the electric bicycle 201 is clear of obstructions (e.g., no objects in the path have been identified), and thus, engage the motor in a manner so as to move the electric bicycle forward along the forward path. Likewise, the electronic device 104 may determine, based on the sensor data, that an object is obstructing the path, and thus, may cause the motor to stop, and/or reduce the speed of the electric bicycle 201.

In an example, the computing device 101 may analyze environmental information (e.g., sensor data, LIDAR data, etc.) and provide feedback to the operator of the bicycle 201. Haptic and/or auditory feedback may be provided to the operator to indicate how to navigate through the environment. For example, feedback may be provided to the operator to facilitate the operator following a predetermined route. This can be accomplished by the computing device 101 identifying a predetermined route and receiving and analyzing GPS information to provide feedback to the operator regarding macro adjustments to the current route (e.g., turn right, turn left). For example, if the GPS information indicates that, in order to stay on the path, the operator must make a left turn, the first haptic feedback fixture 103 on the left handlebar of the bicycle 201 may be activated. Likewise, if the GPS information indicates that, in order to avoid an object, the operator must move to the right, the second haptic feedback fixture 103 on the right handlebar may be activated. In an example, the computing device 101 may analyze sensor data to provide feedback to the operator regarding micro adjustments to the current route (e.g., veer right, veer left, stop, etc.). Micro adjustments can advantageously allow the operator to avoid obstacles while maintaining course. In an example, a motor of an electric bicycle may be controlled by the computing device 101 to propel the electric bicycle and thereby transport the operator along a predetermined route. The computing device 101 may use the environmental information to control the motor of the electric bicycle such that the motor may stop, or reduce the speed of, the electric bicycle to avoid the detected object(s) along the path.

In an example, the electronic device 102 may be in communication with the computing device 101. The electronic device 102 may communicate with the computing device 101 to send the environmental information to the computing device 101 and to receive operating instructions from the computing device 101. For example, the computing device 101 may include a GPS capability and a maps application (e.g., Google Maps™) that may generate a route for the operator of the bicycle 201. The computing device 101 may be configured to send instructions to the electronic device 102 and the electronic device 102 may carry out those instructions, for example, to provide route feedback to the operator of the bicycle 201. In combination with the computing device 101 managing the route, the electronic device 102 may be configured to monitor environmental information received from the LIDAR sensor, provide the environmental information to the computing device 101, and receive directional data from the computing device 101 based on the environmental information.

FIG. 3 shows an example handle bar 300 of the bicycle 201, comprising the first haptic feedback fixture 103 affixed to the left handlebar 301, and the second haptic feedback fixture 103 affixed to the right handlebar 302. Each haptic feedback fixture 103 may comprise a speaker device 303, 304 and a vibration motor 305, 306 for providing audio and tactile feedback to the operator of the bicycle 201. The audio and tactile feedback may comprise a voice output and a vibration output, respectively. When an object is detected on the left, the computing device 101 may cause the first haptic feedback fixture 103 on the left handlebar 301 to alert the operator of the identified objects on the left using the speaker device 303 and/or the vibration motor 305. When an object is detected on the right, the computing device 101 may cause the second haptic feedback fixture 103 on the right handlebar 302 to alert the operator of the identified objects on the right using the speaker device 304 and/or the vibration motor 306. Both haptic feedback fixtures 103 may be activated simultaneously to alert the operator of any detected objects approaching the center. In an example, the computing device 101 may be affixed to the center of the handlebar 300, as shown in FIG. 3. In an example, the speaker device 303, 304 may comprise earphones, or earbuds, that may be separate devices from the haptic feedback fixtures 103. For example, the earphones, or earbuds, may be configured to communicate with the computing device 101 via a wired or wireless communication interface, wherein the computing device 101 may provide audio feedback to the user via the earphones, or earbuds.

FIG. 4 shows an example haptic feedback fixture 103. Each haptic feedback fixture 103 may comprise a cone 403 to direct the sound of the speaker device 402, and a thumb placement portion for access to the vibration motor 401. Both the vibration motor 401 and the speaker device 402 may be located on the bottom piece of the haptic feedback fixture 103 that attaches to the handlebar of the bicycle 201. In an example, the speaker device 402 may comprise a piezoelectric speaker and the vibration motor 401 may comprise a lilypad vibration motor.

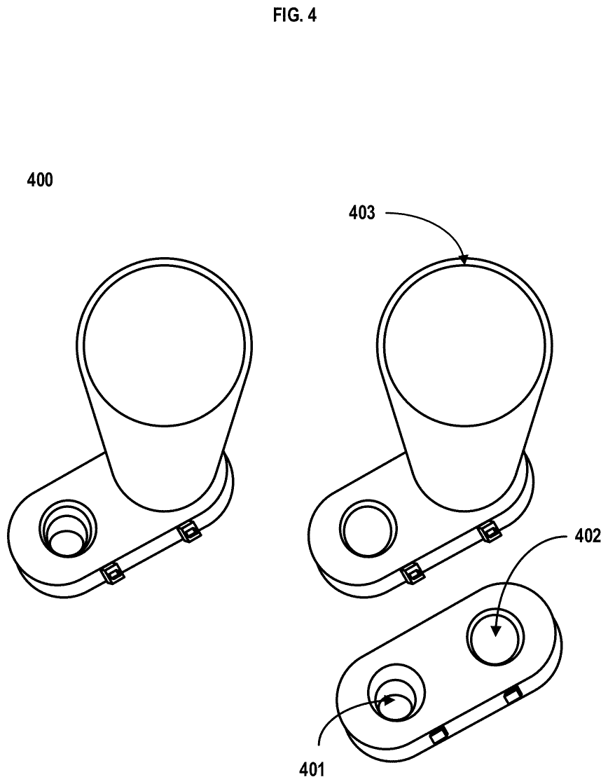

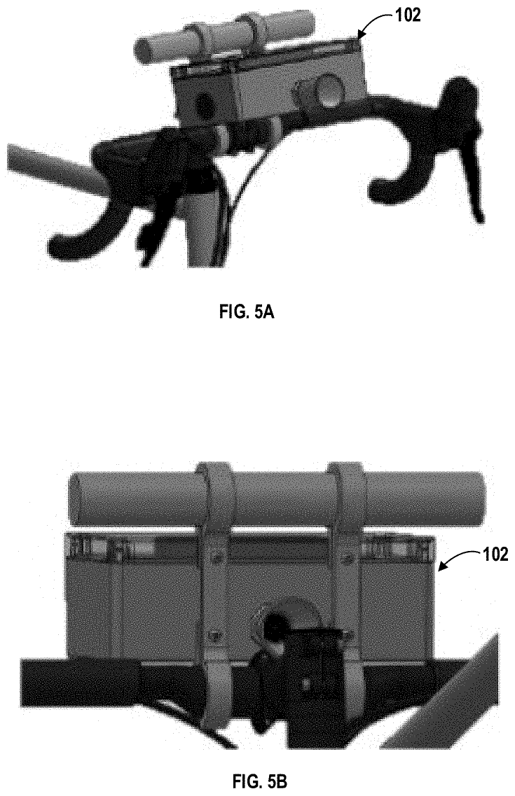

FIGS. 5A-5B show an example sensor that may be affixed to a handlebar of a bicycle. For example, the electronic device 102 (e.g., sensor device) may be affixed to a handlebar of a bicycle. The electronic device 102 may be positioned to point towards a forward path in front of the bicycle to detect objects in the forward path of the bicycle and the speaker and speaker cone may be configured to point towards the operator of the bicycle to provide audio feedback to the operator. In an example, the electronic device 102 and feedback system may be configured to output slightly different feedback as a detected object approaches the bicycle. For example, the electronic device 102 (e.g., sensor device) may be configured to determine a distance between the bicycle and one or more objects. A computing device may receive data indicative of the detected objects and distance to the bicycle and may be configured to cause the speaker device to output a frequency of beeps to the operator. The computing device may cause the frequency of beeps to increase as the objects get closer to the bicycle. For example, the audible beeps may occur more frequently as the distance between the detected objects and the bicycle decreases.

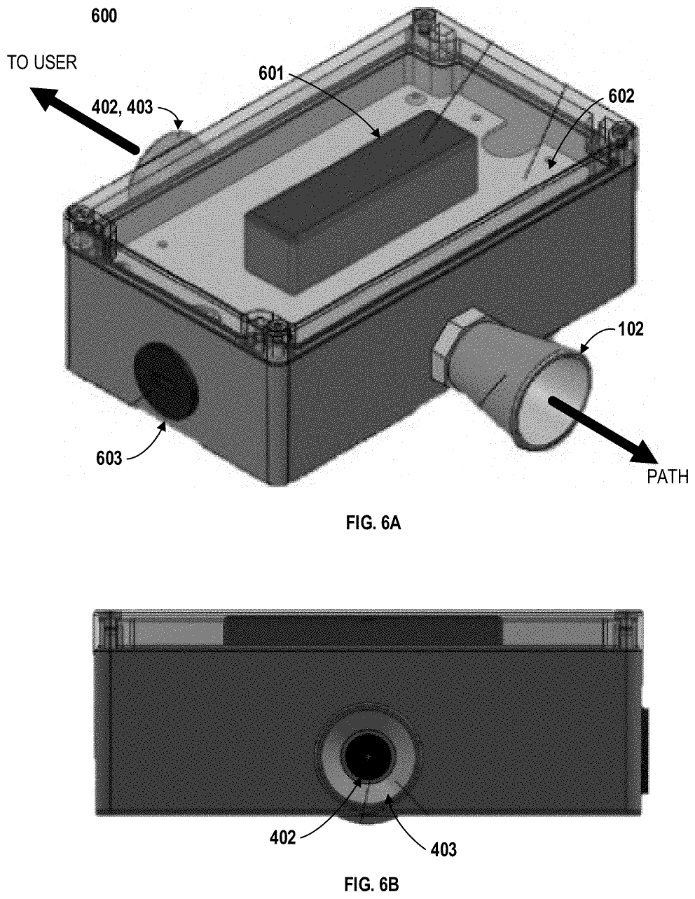

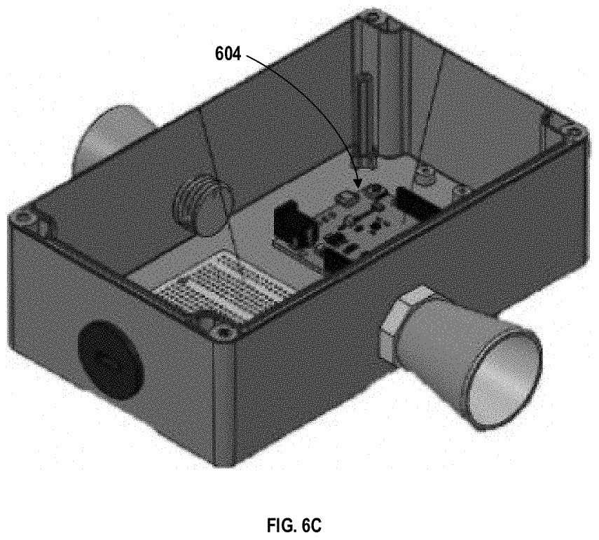

FIGS. 6A-6C show an example sensor design 600. In an example, the electronic device 102 (e.g., sensor device) may be configured as single sensor device design 600 that may include sensor device 102, speaker device 402, speaker cone 403, a battery 601, a platform 602, a battery charging port 603, and a processing device 604. In an example, the sensor device 600 may be affixed to a top portion of a handlebar of a bicycle. As shown in FIG. 6A, the sensor device 600 may be positioned on the handlebar such that the speaker device 402 and speaker cone 403 may be pointed in the direction towards an operator of the bicycle and the electronic device 102 (e.g., sensor device) may be pointed in a forward direction towards the front of the bicycle. The platform 602 may be used to separate the sensor device 600 into two portions. The battery 601 may be affixed to a top portion of the sensor device 600, as shown in FIG. 6A. The processing device 604 may be affixed to a bottom portion of the sensor device 600, as shown in FIG. 6C. The battery 601 may be configured to power the electronic components of the sensor device 600, such as the sensor device 102, the speaker device 402, and the processing device 604. The battery 601 may comprise a portable battery that may be configured to connect to the battery charging port 603 via an extension cable. The processing device 604 may comprise one or more of a microcontroller, a Central Processing Unit (CPU), an Application Processor (AP), a Field Programmable Gate Array (FPGA), or a Communication Processor (CP). The processing device 604 may be configured to control the operations of the sensor device 600 based on connections to the battery 601 for power, the sensor device 102 for object detection, vibration motors 401 for tactile feedback, and the speakers 402 for audio feedback. The speaker cone 403 may be configured to amplify the audio feedback towards the operator.

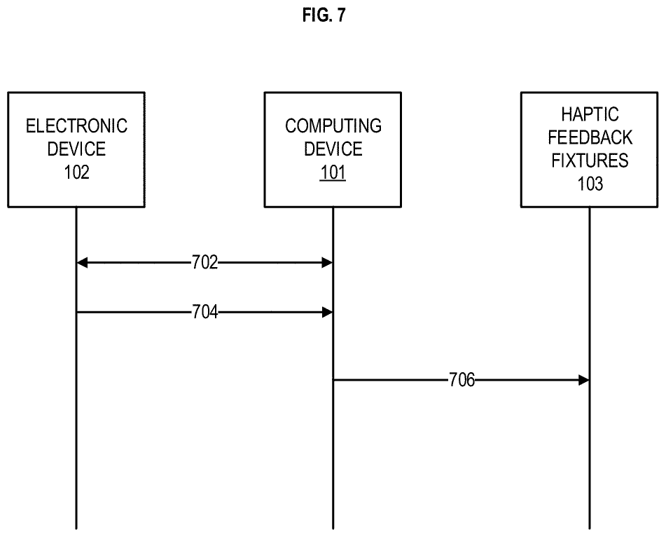

FIG. 7 shows a flowchart of an example process for navigation using the computing device 101, the electronic device 102, and the haptic feedback fixtures 103. The computing device 101 (e.g., computing device, smartphone, tablet, etc.) may initiate communication with the electronic device 102 (e.g., LIDAR sensor) at 702. For example, the computing device 101 may be configured to initiate a wireless communication session such as a Bluetooth communication session. At 704, the computing device 101 may receive environmental data from one or more sensors of the electronic device 102. For example, the one or more sensors may determine the environmental data and send the environmental data to the computing device 101. For example, a LIDAR sensor may determine the environmental data and send the environmental data to the computing device 101. The environmental data may indicate a presence of one or more objects in proximity to the electronic device 102. The computing device 101 may analyze the environmental data and generate directional data based on the environmental data. The directional data may indicate a direction and/or a distance (e.g., a vector) of the one or more objects with respect to the electronic device 102. At 706, the computing device 101 may process the directional data to determine one or more signals based on the directional data. The one or more signals may be used to determine the appropriate haptic feedback fixture to control in order to provide audio (e.g., voice) and vibration outputs to the operator to signal to the operator to avoid a detected object. For example, the one or more signals may indicate that the first haptic feedback fixture 103 on the left handlebar 301 needs to output, via the speaker device 303 and the vibration motor 305, an audio (e.g., voice) output and a vibration output to the operator to avoid an object on the left. In an example, wherein the bicycle 201 comprises an electric bicycle, the computing device 101 may be configured to control the motor of the electric bicycle to stop, or reduce the speed of, the electric bicycle with respect to an object detected in front of the bicycle 201.

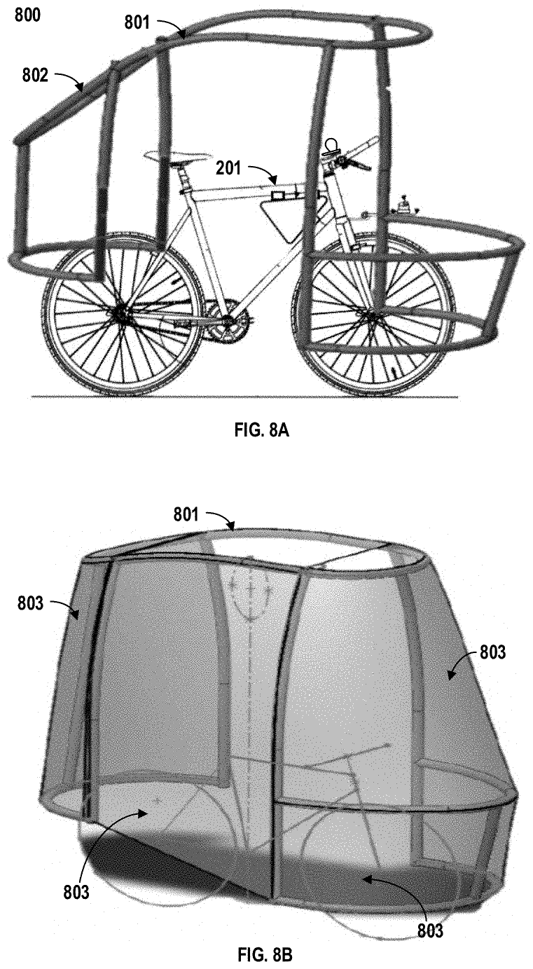

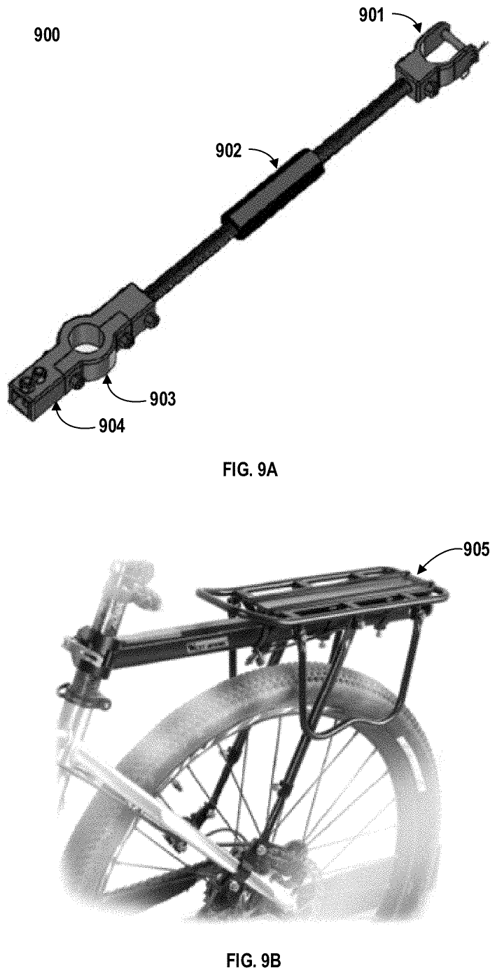

FIGS. 8A-8B show an example protective enclosure 801 that may be configured to shield an operator of the bicycle 201 from unfavorable weather elements, such as high winds, heavy rain, and debris. The enclosure 801 may be affixed to the bicycle 201 via a front mounting bracket and a rear frame attachment. As shown in FIGS. 8A-8B, the enclosure 801 may comprise a metal frame 802, one or more protective panels 803, and one or more mounting mechanisms. For example, the mounting mechanism may comprise mounting mechanism 900 shown in FIGS. 9A-9B. In an example, the frame 802 may be configured to provide the structure for which to mount the protective panels 803. The frame 802 may comprise a metal material (e.g., steel alloy, aluminum, etc.), to provide a sturdy cage inside which the operator may reside. As shown in FIGS. 8A-8B, the frame 802 may be configured to enclose a majority of the bicycle 201 except for the undercarriage and rear real of the bicycle 201. A front portion of the frame 802 may comprise two curved front portions that may be configured to encircle the front wheel in a manner that provides for an area surrounding the front wheel of the bicycle 201 that enables the front wheel to be turned freely without obstruction. A rear portion of the frame 802 may comprise a vertical portion and a diagonal portion. The diagonal portion may comprise a bottom portion of the frame 802, which may be configured to slope in an upward direction to a lower attachment hinge on the rear vertical portion of the frame 802. The rear portion of the frame 802 may be affixed (e.g., attached) to a mount rack affixed to a rear portion of the bicycle 201. The front and rear vertical portions of the frame 802 may comprise a height of 63.4 inches, although any height may be contemplated. The front portion of the frame 802 and the front vertical portions of the frame 802 may be configured in a manner that provides a shape for a curved windshield that encloses the handlebars and sensor array of the bicycle 201. Door portions of the frame 802 may be configured to mount on the rear vertical portions of the frame 802 via one or more hinges (e.g., one or more hinges for each of the rear vertical portions) and attach to the front vertical portion via a latch. The latch may be configured to be released via a handle or button.

FIG. 8B shows an example of the protective enclosure 801, wherein the protective panels 803 may be affixed (e.g., attached) to the outside of the frame 802. The protective panels 803 may be configured as a barrier between the operator and outside conditions (e.g., unfavorable weather elements such as high winds, heavy rain, and debris). The protective panels 803 may comprise a transparent, flexible, UV-, and impact-resistant material (e.g. one or more ⅛-inch polycarbonate sheets). In addition, the material comprising the protective panels 803 may further comprise a material configured to enable infrared signals of the sensor device to be output through the protective panels 803 to enable detection of objects in the forward path of the bicycle. The protective panels 803 may comprise a plurality of panels, such as a one or more front panels, one or more door panels, a top panel, and one or more rear panels. The protective panels 803 may be configured to be fixed in place on the frame 802. The door panels may be configured as doors that may be opened and closed by the operator of the bicycle 201. In an example, the door panels may be locked while the operator is operating the bicycle 201. In an example, one or more balancing masses (e.g., weights) may be affixed to the lower portions of the protective enclosure 801. The balancing masses may function to lower the center of gravity of the operator of the bicycle 201. In an example, additional wheels (e.g. training wheels) may be affixed to the side portions of the protective enclosure 801. The additional wheels may be configured to prevent the bicycle 201 and the affixed protective enclosure 801 from tipping over due to strong cross winds.

FIGS. 9A-9B show example mounting mechanisms 900. For example, the mounting mechanisms may comprise a front mounting mechanism, as shown in FIG. 9A, and a rear mounting mechanism, as shown in FIG. 9B. The front mounting mechanism may comprise a front mount 901 and a turnbuckle 902. The frame 802 may be affixed to the bicycle 201 via the front and rear mounting mechanisms. In an example, the front mounting mechanism may be adjustable to account for any dimensional variations of the frame 802. The front mount 901 may comprise a clamp body that may be configured to attach to a turnbuckle-like mechanism 902. Via axial rotation of the turnbuckle 902, the front mount 901 may be configured to extend or contract to mate with the inside of the bicycle's 201 tubing, such as between the seat tube and the head tube. A clamp interface 903 may be configured at the opposite end of the front mount 901, as shown in FIG. 9A. Extending forward from the clamp 903 (e.g., under the bicycle's 201 handlebars) may be an insertion point 904 for crossmember tubes that may be configured to connect to the frame 802 portions (e.g., frame members). In an example, as shown in FIG. 9B, a second mounting mechanism may be affixed to a rear portion of the bicycle 201. The second mounting mechanism may comprise a luggage rack 905. The rear portion of the second mechanism, including the luggage rack 905, may be affixed (e.g., mounted, attached, etc.) at the seat tube and seat stays of the bicycle 201. The rear portion of the frame 802 (e.g., rear frame members) may be affixed (e.g., mounted, attached, etc.) to the luggage rack 905. For example, the second mounting mechanism may provide rear structural support for the protective enclosure 801, in addition to the mounting mechanism 900.

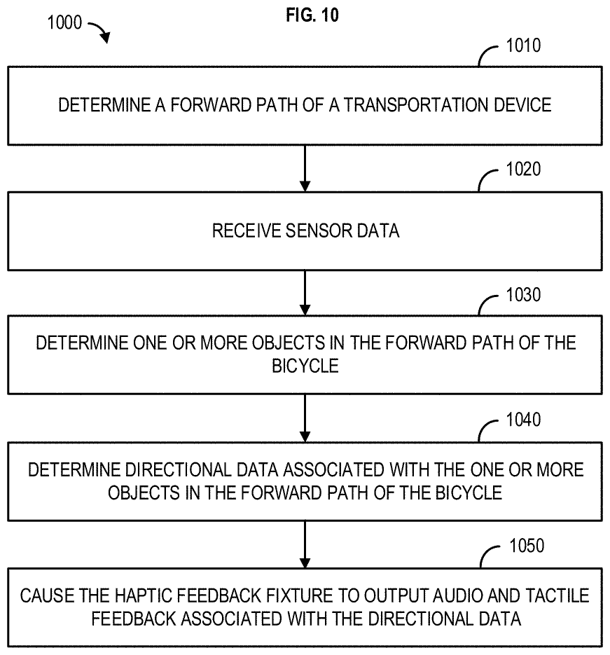

FIG. 10 shows a flowchart of an example method 1000. The method 1000 may be implemented by a computing device such as computing device 101, electronic device 102, electronic device 104, combinations thereof, and the like. At step 1010, a forward path of the bicycle may be determined. The forward path may comprise a direction of travel, navigational information associated with a destination, turn-by-turn directions, combinations thereof, and the like. The forward path may be determined based on GPS information. For example, the GPS information may comprise a map and/or directions to a destination. The path of the bicycle 201 may comprise a route between a present location of the bicycle 201 (and be extension, the operator) and the destination.

At step 1020, sensor data may be received. For example, the sensor data may be received by a computing device (e.g., computing device 101, electronic device 104, etc.) from a sensor device (e.g., the electronic device 102). In an example, the sensor device may comprise a LIDAR sensor. In an example, the sensor device may be configured to use a combination of sensors (e.g. one or more sensors) to identify objects in the path of a bicycle 201 being operated by an operator. The sensor data may be output to a computing device (e.g., computing device 101, electronic device 104, etc.) for processing. For example, the LIDAR sensor may emit a light and in response, receive a light signal. The LIDAR sensor may determine a time of flight or change in frequency associated with the emitted light signal and the received light signal.

At step 1030, one or more objects in the forward path of the bicycle 201 based on the sensor data. For example, the computing device (e.g., computing device 101, electronic device 104) may receive, from the LIDAR sensor, a time of flight or change in frequency associated with the emitted light signal and the received light signal. Based on the received time of flight or change in frequency, the computing device (e.g., computing device 101, electronic device 104) may determine a distance between the LIDAR sensor and an object. Determining the one or more objects in the path of the bicycle 201 may comprise determining, based on the LIDAR data, a position of an object with respect to the LIDAR sensor (and by extension, the operator of the bicycle 201).

At step 1040, directional data associated with the one or more objects in the forward path of the bicycle 201 may be determined. The directional data may comprise data indicative of a direction and/or distance (e.g., a vector) of the one or more objects with respect to the bicycle 201.

At step 1050, the haptic feedback fixtures 103 may be caused to output audio and tactile feedback to the operator based on the directional data. The computing device (e.g., computing device 101, electronic device 104) may process the directional data to determine one or more signals based on the directional data. For example, based on the LIDAR data, the computing device (e.g., computing device 101, electronic device 104) may determine one or more signals that may indicate the first haptic feedback fixture 103 on the left handle bar 301 of the bicycle 201 needs to output, via the speaker device 303 and the vibration motor 305, an audio (e.g., voice) output and a vibration output to the operator to avoid an object in the left direction of the bicycle 201. For example, based on the LIDAR data, the computing device (e.g., computing device 101, electronic device 104) may determine one or more signals that may indicate the second haptic feedback fixture 103 on the right handle bar 302 of bicycle 201 needs to output, via the speaker device 304 and the vibration motor 306, an audio (e.g., voice) output and a vibration output to the operator to avoid an object in the right direction of the bicycle 201. For example, based on the LIDAR data, the computing device (e.g., computing device 101, electronic device 104) may determine one or more signals that may indicate both the first and the second haptic feedback fixtures 103 need to output, via the speaker devices 303, 304 and the vibration motors 305, 306, an audio (e.g., voice) output and a vibration output to the operator to avoid an object in the center direction of the bicycle 201. In an example, wherein the bicycle 201 comprises an electric bicycle, the computing device (e.g., computing device 101, electronic device 104) may control the motor of the electric bicycle to slow down, or stop, with respect to an object detected in front of the bicycle 201.

In an example, the LIDAR data may be output to a server. For example, the computing device (e.g., computing device 101, electronic device 104) may be configured to receive the LIDAR data and send the LIDAR data to the server. The server may be configured to process the LIDAR data to determine directional data associated with the one or more objects in the forward path of the bicycle 201. The server may send the direction data to the computing device (e.g., computing device 101, electronic device 104), wherein the computing device (e.g., computing device 101, electronic device 104) may cause at least one of the haptic feedback fixtures 103 to output via at least one of the speaker devices 303, 304 and/or at least one of the vibration motors 305, 306, an audio (e.g., voice) output and a vibration output to the operator to avoid an object in the center direction of the bicycle 201.

In an example, turn-by-turn guidance associated with the path may be determined. For example, a speaker device and/or a vibration motor of the haptic feedback fixture may be configured to output audio (e.g., voice) and vibration feedback associated with the turn-by-turn guidance associated with the forward path.

In an example, directional data may be determined based on the one or more objects in the forward path of the apparatus. The directional data may be output to the computing device (e.g., computing device 101, electronic device 104). Audio (e.g., voice) and/or vibration feedback may be output, via a speaker device and/or a vibration motor of the haptic feedback fixture(s) based on the directional data.

The transportation device may comprise a steering device affixed to the transportation device, a cargo rack affixed to the transportation device, a sensor mount affixed to the cargo rack, one or more sensors affixed to a top surface of the sensor mount and configured for detecting an environment in the forward path of the transportation device, a first haptic feedback fixture affixed to a left side of the steering device and configured to provide audio and/or tactile feedback, and a second haptic feedback fixture affixed to a right side of the steering device and configured to provide audio and/or tactile feedback.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A transportation device comprising:
a steering device, affixed to the transportation device;
a sensor affixed to a front portion of the transportation device, wherein the sensor is four degrees centered on either side from a forward path of the transportation device, wherein the sensor is configured to generate sensor data;
a first haptic feedback fixture affixed to a left side of the steering device, wherein the first haptic feedback fixture comprises a tactile feedback device;
a second haptic feedback fixture affixed to a right side of the steering device, wherein the second haptic feedback fixture comprises a tactile feedback device; and
a computing device in communication with the sensor, the first haptic feedback fixture, and the second haptic feedback fixture, wherein the computing device is configured to:
determine the forward path of the transportation device;
receive the sensor data;
determine, based on the sensor data, one or more objects in the forward path of the transportation device;
determine, based on the one or more objects in the forward path of the transportation device, directional data;
cause, based on the directional data indicating the one or more objects in a left direction of the transportation device, the first haptic feedback fixture to output, via the tactile feedback device of the first haptic feedback fixture, a vibration output to avoid the one or more objects in the left direction of the transportation device; and
cause, based on the directional data indicating the one or more objects in a right direction of the transportation device, the second haptic feedback fixture to output, via the tactile feedback device of the second haptic feedback fixture, a vibration output to avoid the one or more objects in the right direction of the transportation device.

2. The transportation device of claim 1, wherein the steering device comprises a left handle and a right handle, wherein the first haptic feedback fixture is affixed to the left handle and the second haptic feedback fixture is affixed to the right handle.

3. The transportation device of claim 1, wherein the sensor is a Light Detection and Ranging (LIDAR) sensor.

4. The transportation device of claim 3, wherein to determine the one or more objects in the forward path of the transportation device, the computing device is configured to:
receive LIDAR sensor data from the LIDAR sensor; and
determine, based on the LIDAR sensor data, a position of an object.

5. The transportation device of claim 4, further comprising transmitting the LIDAR sensor data to a server.

6. The transportation device of claim 1, further comprising wherein the computing device is affixed to the transportation device.

7. The transportation device of claim 1, wherein the computing device is a smartphone, smart watch, a smart glass, a tablet, or a laptop.

8. The transportation device of claim 1, wherein the transportation device is a bicycle.

9. The transportation device of claim 1, wherein the transportation device is an electric bicycle; and wherein the computing device is configured to engage, based on the directional data, an electric motor of the electric bicycle.

10. The transportation device of claim 1, wherein the first haptic feedback fixture further comprises a speaker device and the second haptic feedback fixture further comprises a speaker device.

11. The transportation device of claim 10, wherein the computing device is further configured to:
cause, based on the directional data indicating the one or more objects in a left direction of the transportation device, the first haptic feedback fixture to output, via the speaker device of the first haptic feedback fixture, a voice output to avoid the one or more objects in the left direction of the transportation device; and
cause, based on the directional data indicating the one or more objects in a right direction of the transportation device, the second haptic feedback fixture to output, via the speaker device of the second haptic feedback fixture, a voice output to avoid the one or more objects in the right direction of the transportation device.

12. The transportation device of claim 10, wherein the computing device comprises a GPS component configured to:
determine turn-by-turn guidance associated with the forward path;
cause, based on a left-turn guidance indicated by the turn-by-turn guidance associated with the forward path, the first haptic feedback fixture to output, via the speaker device and the tactile feedback device of the first haptic feedback fixture, a voice output and a vibration output associated with the left-turn guidance; and
cause, based on a right-turn guidance indicated by the turn-by-turn guidance associated with the forward path, the second haptic feedback fixture to output, via the speaker device and the tactile feedback device of the second haptic feedback fixture, a voice output and a vibration output associated with the right-turn guidance.

13. A method comprising:
determining a forward path of a transportation device;
the transportation device comprising:
a steering device, affixed to the transportation device;
a sensor affixed to a front portion of the transportation device, wherein the sensor is four degrees centered on either side from the forward path of the transportation device, wherein the sensor is configured to generate sensor data;
a first haptic feedback fixture affixed to a left side of the steering device, wherein the first haptic feedback fixture comprises a tactile feedback device;
a second haptic feedback fixture affixed to a right side of the steering device, wherein the second haptic feedback fixture comprises a tactile feedback device; and
a computing device in communication with the sensor, the first haptic feedback fixture, and the second haptic feedback fixture, wherein the computing device is configured to:
receive the sensor data;
determine, based on the sensor data, one or more objects in the forward path of the transportation device;
determine, based on the one or more objects in the forward path of the transportation device, directional data;
cause, based on the directional data indicating the one or more objects in a left direction of the transportation device, the first haptic feedback fixture to output, via the tactile feedback device of the first haptic feedback fixture, a vibration output to avoid the one or more objects in the left direction of the transportation device; and
cause, based on the directional data indicating the one or more objects in a right direction of the transportation device, the second haptic feedback fixture to output, via the tactile feedback device of the second haptic feedback fixture, a vibration output to avoid the one or more objects in the right direction of the transportation device.

14. The method of claim 13, wherein the steering device comprises a left handle and a right handle, wherein the first haptic feedback fixture is affixed to the left handle and the second haptic feedback fixture is affixed to the right handle.

15. The method of claim 13, wherein the sensor is a Light Detection and Ranging (LIDAR) sensor.

16. The method of claim 15, wherein to determine the one or more objects in the forward path of the transportation device, the computing device is configured to:
receive LIDAR sensor data from the LIDAR sensor; and
determine, based on the LIDAR sensor data, a position of an object.

17. The method of claim 16, further comprising transmitting the LIDAR sensor data to a server.

18. The method of claim 13, further comprising wherein the computing device is affixed to the transportation device.

19. The method of claim 13, wherein the computing device is a smartphone, smart watch, a smart glass, a tablet, or a laptop.

20. The method of claim 13, wherein the transportation device is a bicycle.

21. The method of claim 13, wherein the transportation device is an electric bicycle; and wherein the computing device is configured to engage, based on the directional data, an electric motor of the electric bicycle.

22. The method of claim 13, wherein the first haptic feedback fixture further comprises a speaker device and the second haptic feedback fixture further comprises a speaker device.

23. The method of claim 22, wherein the computing device is further configured to:
cause, based on the directional data indicating the one or more objects in a left direction of the transportation device, the first haptic feedback fixture to output, via the speaker device of the first haptic feedback fixture, a voice output to avoid the one or more objects in the left direction of the transportation device; and
cause, based on the directional data indicating the one or more objects in a right direction of the transportation device, the second haptic feedback fixture to output, via the speaker device of the second haptic feedback fixture, a voice output to avoid the one or more objects in the right direction of the transportation device.

24. The method of claim 22, wherein the computing device comprises a GPS component configured to:
determine turn-by-turn guidance associated with the forward path;
cause, based on a left-turn guidance indicated the turn-by-turn guidance associated with the forward path, the first haptic feedback fixture to output, via the speaker device and the tactile feedback device of the first haptic feedback fixture, a voice output and a vibration output associated with the left-turn guidance; and
cause, based on a right-turn guidance indicated by the turn-by-turn guidance associated with the forward path, the second haptic feedback fixture to output, via the speaker device and the tactile feedback device of the second haptic feedback fixture, a voice output and a vibration output associated with the right-turn guidance.
